(19) United States
(12) Patent Application Publication
(10) Pub. No.: US 2016/0223869 A1
(43) Pub. Date: Aug. 4, 2016

(54) LIQUID CRYSTAL DISPLAY AND MANUFACTURING METHOD THEREOF

(71) Applicant: Samsung Display Co., Ltd., Yongin-si (KR)

(72) Inventors: Mun-Ki SIM, Seoul (KR); Young Min KIM, Yongin-si (KR); Seon-Tae YOON, Seoul (KR); Baek Hee LEE, Yongin-si (KR); Min Ki NAM, Anseong-si (KR); Hae Il PARK, Seoul (KR); Jun Han LEE, Incheon (KR)

(21) Appl. No.: 14/886,369

(22) Filed: Oct. 19, 2015

(30) Foreign Application Priority Data
Jan. 29, 2015 (KR) 10-2015-0014347

(51) Int. Cl. G02F 1/1335; G02F 1/1337

(52) U.S. Cl. CPC G02F 1/133617; G02F 1/133553; G02F 1/133528; G02F 1/1337; G02F 1/133603; G02F 2001/133614

(57) ABSTRACT

A liquid crystal display that includes a substrate, a pixel electrode arranged on the substrate, a liquid crystal layer arranged in a microcavity on the pixel electrode, a roof layer supporting the microcavity and a capping layer arranged on the roof layer, wherein the capping layer includes a color conversion portion that includes a plurality of quantum dots distributed within a polymer layer. With the above structure, it is possible to reduce weight, thickness, cost, and processing time of the display by using only one substrate and by integrally including the quantum dots within a capping layer.

### CLAIM OF PRIORITY

This application claims priority to and the benefit accruing under 35 U.S.C. §119 from Korean Patent Application No. 10-2015-00′1.4347 filed in the Korean Intellectual Property Office on Jan. 29, 2015, the entire contents of which are incorporated herein by reference.

### BACKGROUND OF THE INVENTION

1. Field of the Invention

The present invention relates to a liquid crystal display including quantum dots and a manufacturing method thereof the display having an improved backlight with improved white color purity while having a slimmer design by eliminating the need for two separate. substrates.

2. Description of the Related Art

A liquid crystal display (LCD) is a non-emissive display that is incapable of emitting light by itself and thus incident light from the outside is required to display an image. Accordingly, a backlight unit (BLU) for emitting light is positioned at a rear side of an LCD.

Recently, a BLU using three color light emitting diodes (LEDs) has been developed, and the BLU using these three color LEDs as a light source can implement high color purity, thereby being applicable to high quality display devices. Particularly, a white LED is being developed in which light emitting out of a single color LED chip is convened into white light.

However, while the white LED is economically feasible, it has a problem that color purity and color reproducibility are low, and thus efforts for using a semiconductor nanocrystal as the BLU have recently been made to improve the color reproducibility and the color purity and to ensure price competitiveness.

In addition, two sheets of display panels of which the LCD consists may include a thin film transistor array panel and an opposing display panel. That is, in the conventional LCD, two substrates are indispensably used and constituent elements are separately formed on the two substrates, thereby requiring a long processing time while causing the display to be heavy, thick, and costly.

The above information disclosed in this Background section is only for enhancement of understanding of the background of the invention, and therefore it may contain information that does not constitute prior an as per 35 U.S.C. 102, taken either prior to or after the AIA.

### SUMMARY OF THE INVENTION

The present invention has been made in an effort to provide a liquid crystal display and a manufacturing method thereof that may reduce weight, thickness, cost, and processing time by using only one substrate while including quantum dots within a capping layer.

According to one aspect of the present invention, there is provided a liquid crystal display device, including a substrate, a pixel electrode arranged on the substrate, a liquid crystal layer arranged in a microcavity on the pixel electrode, a roof layer supporting the microcavity and a capping layer arranged on the roof layer and having a thickness in the range of 50 to 100 microns, wherein the capping layer includes a color conversion portion that includes a plurality of quantum dots distributed within a polymer layer.

The quantum dots may include a plurality of red quantum dots and a plurality of green quantum dots. The polymer layer may include a plastic resin that transmits light. The capping layer may also include a barrier portion arranged on at least one surface of the color conversion portion. The barrier portion may include at least one of polyethylene terephthalate (PET) film, a polycarbonate (PC) film, and a co-polyethylene terephthalate (CoPET) film. Each of the quantum dots and the barrier portion include at least one of silica, alumina, titania, zirconia, and a combination thereof. The liquid crystal display device may also include a first alignment layer arranged on the pixel electrode, a second alignment layer facing the first alignment layer with the microcavity therebetween and a common electrode arranged on the second alignment layer. The display device may also include a planar LED light source that emits either blue visible light or ultraviolet light, the light source may he arranged on an opposite side of the capping layer than the liquid crystal layer.

According to another aspect of the present invention, there is included a liquid crystal display, including a substrate, a pixel electrode arranged on the substrate, a liquid crystal layer arranged on the pixel electrode, a common electrode arranged on the liquid crystal layer and forming a microcavity with the pixel electrode, a roof layer supporting the microcavity, a first capping layer arranged on the roof layer, a polarizer arranged on the first capping layer and a second capping layer and a third capping layer sequentially arranged on the polarizer, wherein the second capping layer having a thickness within a range of 50 to 100 microns and includes a plurality of quantum dots dispersed within a polymer layer.

The quantum dots may include a plurality of red quantum dots and a plurality of green quantum dots. The first capping layer and the third capping layer may include a polymer layer that is absent of any quantum dots. The polymer layer of each of the first, second and third capping layers may include a plastic resin that transmits light. The quantum dots may include at least one of silica, alumina, titania, zirconia, and a combination thereof. The display device may also include a first alignment layer arranged on the pixel electrode, a second alignment layer facing the first alignment layer with the microcavity therebetween and a common electrode arranged on the second alignment layer. The third capping layer may include a reflecting film. The reflecting film may transmit blue light while reflecting both green light and red light. The reflecting film may include at least one layer including silicon oxide and at least one layer including titanium oxide. The display device may also include a reflecting film arranged on the third capping layer. The reflecting film may transmit blue light while reflecting both green light and red light.

### BRIEF DESCRIPTION OF THE DRAWINGS

A more complete appreciation of the invention, and many of the attendant advantages thereof, will be readily apparent as the same becomes better understood by reference to the following detailed description when considered in conjunction with the accompanying drawings, in which like reference symbols indicate the same or similar components, wherein:

FIG. 1 is a cross-sectional view of a liquid crystal display according to a first exemplary embodiment of the present invention;

FIG. 2 is an enlarged cross-sectional view of a capping layer shown in FIG. 1;

FIG. 3 a cross-sectional view of a liquid crystal display according to a second exemplary embodiment of the present invention;

FIG. 4 is a cross-sectional view of a liquid crystal display according to a third exemplary embodiment of the present invention; and

FIG. 5 is a cross-sectional view of a liquid crystal display according to a fourth exemplary embodiment of the present invention.

### DETAILED DESCRIPTION OF THE INVENTION

The present invention will be described more fully hereinafter with reference to the accompanying drawings, in which exemplary embodiments of the invention are shown. As those skilled in the art would realize, the described embodiments may be modified in various different ways, all without departing from the spirit or scope of the present invention.

In the drawings, the thickness of layers, films, panels, regions, etc., are exaggerated for clarity. Like reference numerals designate like elements throughout the specification. It will be understood that when an element such as a layer, film, region, or substrate is referred to as being “on” another element, it can be directly on the other element or intervening elements may also be present. In contrast, when an element is referred to as being “directly on” another element, there are no intervening elements present.

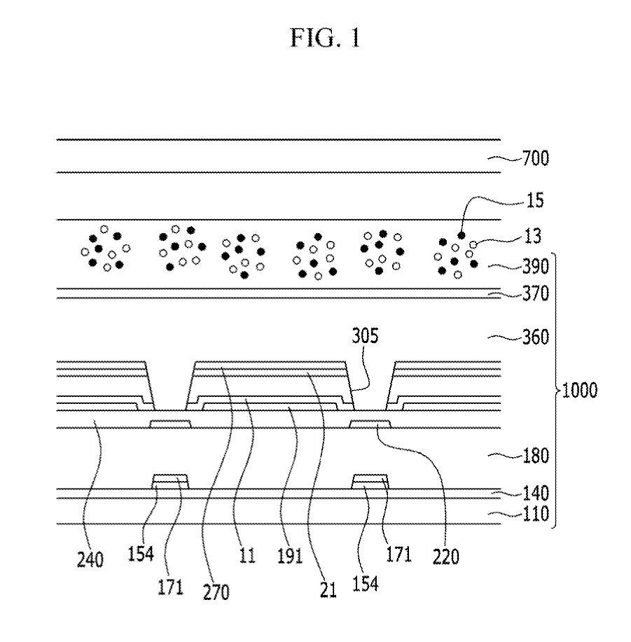

A liquid crystal display according to a first exemplary embodiment of the present invention will be now described in detail with reference to FIG. 1. Turning now to FIG. 1, FIG. 1 is a cross-sectional view of a liquid crystal display according to a first exemplary embodiment of the present invention. Referring now to FIG, 1, a liquid crystal panel 1000 includes a substrate 110, a plurality of gate lines (not shown), a gate insulation layer 140, a plurality of semiconductors 154, a plurality of data lines 171, and a passivation layer 180.

A plurality of light blocking members 220 and a first insulating layer 240 are disposed on the passivation layer 180. The light blocking members 220 respectively overlap the data lines 171. The first insulating layer 240 covers the light blocking member 220 while producing a flat upper surface.

A pixel electrodes 191 are formed on the first insulating layer 240, a first alignment layer 11 is formed on the pixel electrodes 191, a second alignment layer 21 is arranged to face the first alignment layer 11, and a microcavity 305 is formed between the first alignment layer 11 and the second alignment layer 21.

A liquid crystal material including liquid crystal molecules is injected into the microcavity 305, and a liquid crystal injection hole (not shown) for injecting the liquid crystal material is formed in the microcavity 305. The liquid crystal injection hole (not shown) may be arranged at a lateral surface of the microcavity 305.

A common electrode 270 is disposed on the second alignment layer 21. The common electrode 270 is applied with the common voltage to generate an electric field along with the pixel electrodes 191 to which the data voltage is applied, thereby determining tilt directions of the liquid crystal molecules 310 disposed within the microcavity 305 between the two electrodes. The common electrode 270 forms a capacitor along with the pixel electrodes 191 to maintain an applied voltage even after the thin film transistor is turned off.

In the first exemplary embodiment, the common electrode 270 has been described to be arranged on the microcavity 305, but in another exemplary embodiment, the common electrode 270 may be arranged under the microcavity 305, thereby allowing liquid crystals to be driven according to a coplanar electrode (CE) mode.

A roof layer 360 is arranged on the common electrode 270. The roof layer 360 serves as a structure for supporting the microcavity 305 such that the microcavity 305 arranged between the pixel electrode 191 and the common electrode 270 can maintain its shape. The roof layer 360 may he made out of a photoresist or an organic material.

A second insulating layer 370 made of silicon nitride (SiNx) or silicon oxide (SiOx) is arranged on the roof layer 360, and a capping layer 390 is arranged on the second insulating layer 370. The capping layer 390 covers a liquid crystal injection hole of the exposed microcavity 305 while filling a portion where the liquid crystal injection hole (not shown) is arranged. The capping layer 390 according to the first exemplary embodiment may be filled with a base material which may be an organic material or an inorganic material, and may further include a plurality of quantum dots 13 and 15 dispersed within the base material. The quantum dots 13 and 15 include red quantum dots 13 and green quantum dots 15, and may be distributed within in the capping layer 390. Herein, the capping layer 390 including the quantum dots 13 and 15 may be formed to have a thickness of about 50-100 μm.

A light source 700 emitting light, from an upper portion of the liquid crystal panel 1000 to a lower portion thereof may be arranged within the liquid crystal display. The light source 700 may include a light emitting diode (LED). The light emitting diode (LED) may be a blue color LED or an ultraviolet LED. Further, the light emitting diode (LED) may be a diode for emitting light of a blue wavelength, but it is not limited thereto.

As described above, the reason why the light source 700 for emitting light of a specific wavelength may be used is that the quantum dots 13 and 15 arranged within the capping layer 390 may amplify or generate light of different wavelengths that can also be supplied to the liquid crystal panel 1000. That is, while being positioned to be spaced apart by a predetermined distance from the light source 700, the capping layer 390 that includes the quantum dots 13 and 15 functions as a light converting layer that converts the light emitted from the light source 700 into the white light and allows the produced white light to emit towards the liquid crystal panel 1000.

When the light emitted from the light source 700 passes through the capping layer 390 containing the quantum dots 13 and 15, the white light in which blue, green, and red light are mixed can be produced. In this case, when compositions and sizes of the quantum dots 13 and 15 arranged within the capping layer 390 are varied such that desired ratios of the blue, green, red light can be controlled, white light with excellent color reproducibility and purity may be produced.

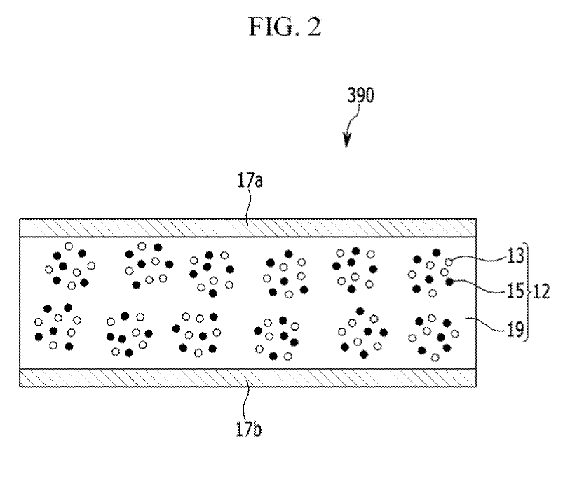

The capping layer 390 containing quantum dots 13 and 15 according to the first exemplary embodiment of the present invention will be now described more fully with reference to FIG. 2. Turning now to FIG. 2, FIG. 2 is an enlarged cross-sectional view of a capping layer shown in FIG. 1. Referring to FIG. 2, the capping layer 390 includes a color conversion portion 12 including a polymer layer 19 in which red quantum dots 13 and green quantum dots 15 are distributed. The polymer layer 19 is made out of a plastic resin. The plastic resin may include various materials that form a polymer or film, and kinds of the materials are not particularly limited. In the exemplary embodiment of the present invention, the plastic resin transmits light, even if it is hardened, and light transmittance is not limited thereto.

The quantum dots 13 and 15 are distributed in the polymer layer 19 of the color conversion portion 12 to implement color reproducibility and color purity. The quantum dots 13 and 15 may be selected from a group II-VI compound, a group IV-VI compound, a group IV element, a group IV compound, and a combination thereof.

The group II-VI compound may be selected from: a group of two-element compounds selected from CdSe, CdTe, ZnS, ZnSe, ZnTe, ZnO, HgS, HgSe, HgTe, MgSe, MgS, and a mixture thereof; a group of three-element compounds selected from CdSeS, CdSeTe, CdSTe, ZnSeS, ZnSeTe, ZnSTe, HgSeS, HgSeTe, HgSTe, CdZnS, CdZnSe, CdZnTe, CdHgS, CdHgSe, CdHgTe, HgZnS, HgZnSe, HgZnTe, MgZnSe, MgZnS, and a mixture thereof; and a group of four-element compounds selected from HgZnTeS, CdZnSeS, CdZnSeTe, CdZnSTe, CdHgSeS, CdHgSeTe, CdHgSTe, HgZnSeS, HgnSeTe, HgZnSTe, and a mixture thereof. A group III-V compound may be selected from: a group of two-element compounds selected from GaN, GaP, GaAs, GaSb, AlN, AlP, AlAs, AlSb, InN, InP, InAs, InSb, and a mixture thereof; a group of three-element compounds selected from GaNP, GaNAs, GaNSb, GaPAs, GaPSb, AlNP, AlNAs, AlNSb, AlPAs, AlPSb, InNP, InNAs, InNSb, InPAs, InPSb, GaAlNP, and a mixture thereof; and a group of four-element compounds selected from GaAlNAs, GaAlNSb, GaAlPAs, GaAlPSb, GalnNP, GalnNAs, GalnNSb, GalnPAs, GalnPSb, InAlNP, InAlNAs, InAlNSb, InAlPAs, InAlPSb, and a mixture thereof. The group IV-VI compound may be selected from: a group of two-element compounds selected from SnS, SnSe, SnTe, PbS, PbSe, PbTe, and a mixture thereof; a group of three-element compounds selected from SnSeS, SnSeTe, SnSTe, PbSeS, PbSeTe, PbSTe, SnPbS, SnPbSe, SnPbTe, and a mixture thereof and a group of four-element compounds selected from SnPbSSe, SnPbSeTe, SnPbSTe, and a mixture thereof. The group IV element may be selected from a group of Si, Ge, and a mixture thereof. The group IV compound may be a two-element compound selected from a group of SiC, SiGe, and a mixture thereof.

In this case, the binary compound, the tertiary compound, or the quaternary compound may be present in particles in uniform concentrations, or may have partially different concentrations in the same particle, respectively. In addition, a core/shell structure in which some quantum dots 13 and 15 enclose some other quantum dots 13 and 15 may be possible. An interfacing surface between the core and the shell may have a concentration gradient in which a concentration of an element decreases closer to its center.

The quantum dots 13 and 15 may have a full width at half maximum (FWHM) of a light-emitting wavelength spectrum of about 45 nm or less, preferably about 40 nm or less, and more preferably about 30 nm or less. In the quantum dots 13 and 15 having the FWHM, the color purity or color reproducibility may be improved.

In addition, shapes of the quantum dots 13 and 15 are not specifically limited to shapes that are generally used in the related art, but specifically, it is desirable that a nanoparticle having a spherical, pyramidal, multi-arm, or cubic shape, and a nanotube, a nanowire, a nanofiber, and a planar nanoparticle are used.

In FIG. 2, the color conversion portion 12 is illustrated to include a mixture of the red quantum dots 13 and the green quantum dots 15 in a same layer, but instead may consist of a first layer including the red quantum dots 13 and a second layer including the green quantum dots 15.

The color conversion portion 12 may further include an inorganic oxide, and the inorganic oxide may be selected from silica, alumina, titania, zirconia, and a combination thereof. The inorganic oxide may act as a light-diffusing material.

The capping layer 390 containing the quantum dots 13 and 15 may further include barrier portions 17a and 17b arranged on opposite surfaces of the color conversion portion 12. However, the barrier portions 17a and 17b may instead be arranged on just one surface thereof.

The barrier portions 17a and 17b may be made out of at least one of a polyethylene terephthalate (PET) film, a polycarbonate (PC) film, and a co-polyethylene terephthalate (CoPET) film. The barrier portions 17a and 17b may further include an inorganic oxide. The inorganic oxide may be selected from silica, alumina, titania, zirconia, and a combination thereof.

In addition, the barrier portions 17a and 17b may have protrusions and depressions on a surface that does not contact the color conversion portion 12. These protrusions and depressions may serve to diffuse light that is emitted from an LED light source.

The barrier portions 17a and 17b may have oxygen permeability of about 0.01 cm³.mm².day.atm to about 0.5 cm³.mm/m².day.atm, and moisture permeability of about 0.001 g/mm².day to 0.01 g/m².day. When within these ranges for the oxygen permeability and for moisture permeability, the quantum dots 13 and 15 may be stably protected from an external environment.

Although not illustrated in FIG. 2, adhesive layers may be further included between the color conversion portion 12 and the barrier portions 17a and 17b. When the barrier portions 17a and 17b serve as a base material, no adhesive layer is required.

In addition, protective films (not shown) may be further included on an external surface of the capping layer 390, that is, on respective surfaces of the barrier portions 17a and 17b that do not contact the color conversion portion 12. The protective film, as a release film, may be made of a polyester such as polyethylene terephthalate.

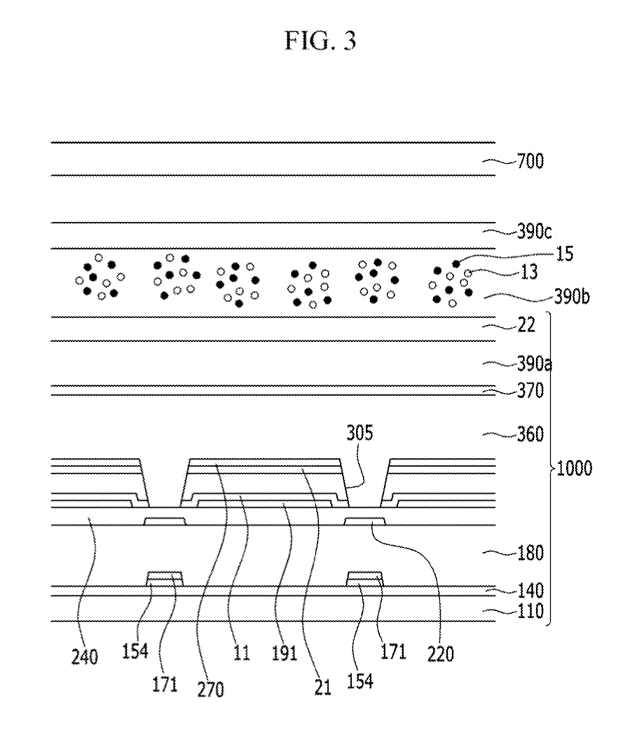

Next, a liquid crystal display according to a second exemplary embodiment of the present invention will be described in detail with reference to FIG. 3. Turning now to FIG. 3, FIG. 3 a cross-sectional view of the liquid crystal display according to the second exemplary embodiment of the present invention.

The liquid crystal display according to the second exemplary embodiment shown in FIG. 3 is substantially the same as the first exemplary embodiment shown in FIG. 1 except that the display of the second embodiment includes a polarizer 22 and a plurality of capping layers, and thus a repeated description will be omitted.

As shown in FIG. 3, a liquid crystal display according to the second exemplary embodiment of the present invention includes a first capping layer 390a arranged on a roof layer 360, a polarizer 22 arranged on the first capping layer 390a, and a second capping layer 390b and a third capping layer 390c sequentially arranged on the polarizer 22. The second capping layer 390b includes quantum dots 13 and 15, and the first capping layer 390a and the third capping layer 390c do not include the quantum dots 13 and 15.

Since the first capping layer 390a and the third capping layer 390c of the second exemplary embodiment may be substituted for the barrier portions 17a and 17b shown in FIG. 2, barrier portions of the second capping layer 390b containing the quantum dots 13 and 15 may be removed.

The polarizer 22 may be a coated-type polarizer or a wire grid polarizer, but it is not limited thereto. In addition, another polarizer may be further disposed below a substrate 110.

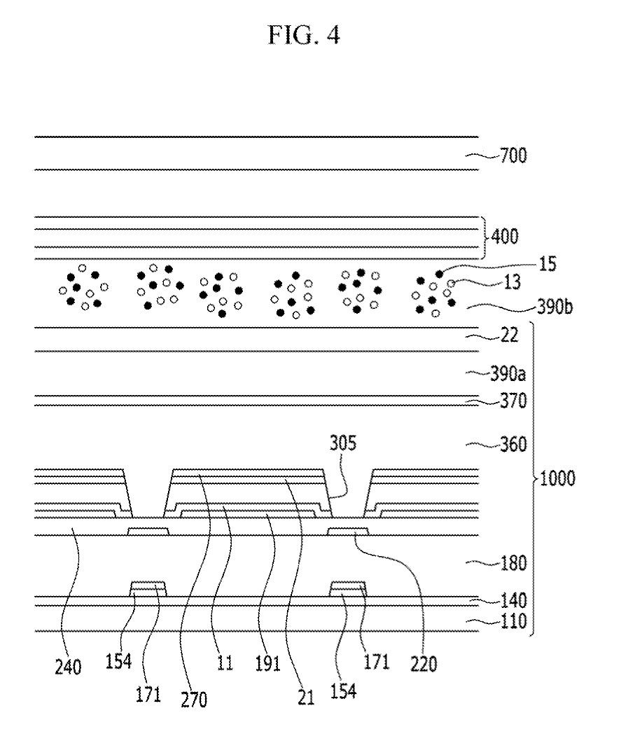

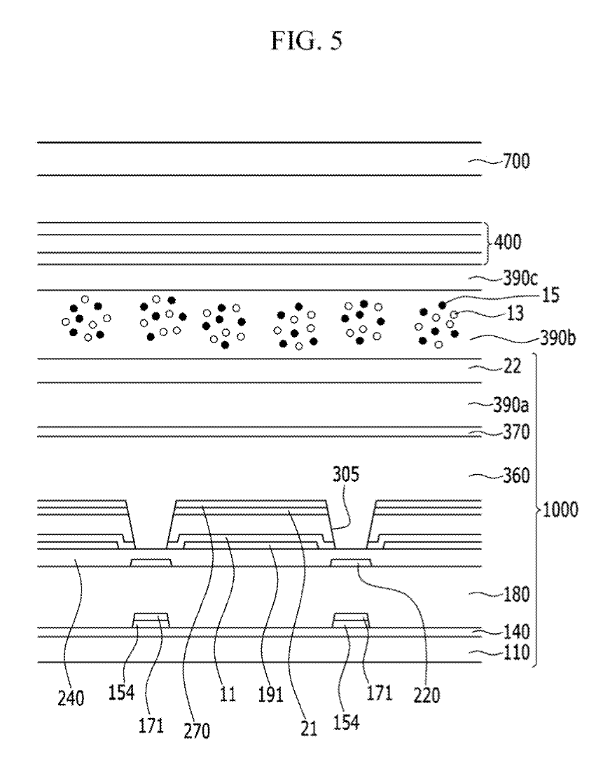

Liquid crystal displays according to the third and fourth exemplary embodiments will now be described with reference to FIGS. 4 and 5 respectively. Turning now to FIGS. 4 and 5, FIGS. 4 and 5 are cross-sectional views of the liquid crystal displays according to the third and fourth exemplary embodiments of the present invention, respectively.

The liquid crystal display of the third exemplary embodiment shown in FIG. 4 is substantially the same as the second exemplary embodiment shown in FIG. 3, except for a reflection film 400 being substituted for the third capping layer 390c, and thus a repeated description will be omitted.

As shown in FIG. 4, the liquid crystal display of the third exemplary embodiment includes the reflection film 400 formed on a top surface of the second capping layer 390b. The reflection film 400 forwardly reflects light emitted from lateral and rear sides of the second capping layer 390b containing quantum dots 13 and 15 to prevent loss of light emitted from the lateral and rear sides of the second capping layer 390b.

The reflection film 400 is a dielectric multilayer of a silicon oxide and a titanium oxide, allowing light, of the blue wavelength range to be transmitted while allowing light of the green and red wavelength ranges to be reflected. The reflection film 400 may be formed to have a thickness of less than 1.5 μm, and preferably has a thickness of 0.1 μm to 1.5 μm.

The reflection film 400 reflects the red and green light of the red and green fluorescent dots, which are redirected from the surfaces other than the front surface, such that they travel towards the front surface and towards the liquid crystal panel 1000, thereby improving the light efficiency. Simultaneously, since the blue light emitted by the light source 700 emitting the blue light is not reflected by the reflection film 400 but is transmitted through the front surface, the overall efficiency of the light emitted toward the front surface from the second capping layer 390b containing quantum dots 13 and 15 may be improved.

Next, referring to FIG. 5, a liquid crystal display according to the fourth exemplary embodiment shown in FIG. 5 is substantially the same as the second exemplary embodiment shown in FIG. 3, except for a reflection film 400 being formed on a capping layer 390c, and thus a repeated description will be omitted.

As shown in FIG. 5, the liquid crystal display of the fourth exemplary embodiment includes the reflection film 400 formed on a top surface of the third capping layer 390c. The reflection film 400 forwardly reflects light emitted from lateral and rear sides of the second capping layer 390b containing quantum dots 13 and 15 to prevent loss of light emitted from the lateral and rear sides of the second capping layer 390b.

The reflection film 400 is the same as that described with reference to FIG. 4, and thus a repeated description will be omitted.

As described above, according to the exemplary embodiment of the present invention, it is possible to reduce weight, thickness, cost, and processing time thereof by using one substrate and integrally including quantum dots in a capping layer. As a result, a second substrate may be omitted, thereby reducing the thickness, weight and complexity of the display.

Unlike earlier attempts to use quantum dots Q in an LCD display device as in FIG. 3 of KR 2013-0123718 to Kim et al, the present invention includes an LCD display device that has a macro-cavity structure that is different from conventional LCD display devices. In conventional LCD display devices, there is only one cell for the entire filled liquid crystal layer. However, an LCD display device having a micro-cavity structure includes a plurality of separated micro-cavities that correspond to the pixels. An example of a micro-cavity LCD display device can be found in US 2015/0015825 to Chae et al.

A conventional LCD that uses quantum dots includes a separate quantum dot sheet with display panels and the backlight unit. However, in the present invention where there are a plurality of micro-cavities that correspond to the pixels, the display can include quantum dots in the capping layer, instead of including a separate quantum dot sheet. By including the quantum dots in the capping layer as opposed to having to include a separate quantum dot sheet, the design for the LCD display device is simplified as a separate quantum dot sheets are not required.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

### DESCRIPTION OF SYMBOLS

110: substrate

140: gate insulating layer

154: semiconductor

171: data line

180: passivation layer

220: light blocking member

240: first insulating layer

191: pixel electrode

11, 21: first, second alignment layer

270: common electrode

305: microcavity

360: root layer

370: second insulating layer

390: capping layer

22: polarizer

12: color conversion portion

13, 15: quantum dots

19: polymer layer

17a, 17b: barrier portion

700: light, source

1000: liquid crystal panel

400: reflection film

What is claimed is:

1. A liquid crystal display device, comprising;
a substrate;
a pixel electrode arranged on the substrate;
a liquid crystal layer arranged in a microcavity on the pixel electrode;
a roof layer supporting the microcavity; and
a capping layer arranged on the roof layer, wherein the capping layer includes a color conversion portion that includes a plurality of quantum dots distributed within a polymer layer.

2. The liquid crystal display device of claim 1, wherein the quantum dots comprise:
a plurality of red quantum dots; and
a plurality of green quantum dots.

3. The liquid crystal display device of claim 2, wherein the polymer layer comprises a plastic resin that transmits light.

4. The liquid crystal display device of claim 3, wherein the capping layer further comprises a barrier portion arranged on at least one surface of the color conversion portion.

5. The liquid crystal display device of claim 4, wherein the barrier portion is comprised of at least one material selected from group consisting of a polyethylene terephthalate (PET) film, a polycarbonate (PC) film, and a co-polyethylene terephthalate (CoPET) film.

6. The liquid crystal display device of claim 5, wherein each of the quantum dots and the barrier portion include at least one inorganic oxide selected from a group consisting of silica, alumina, titania, zirconia, and a combination thereof.

7. The liquid crystal display device of claim 1, further comprising:
a first alignment layer arranged. on the pixel electrode;
a second alignment layer facing the first alignment layer with the microcavity therebetween; and
a common electrode arranged on the second alignment layer.

8. The liquid crystal display device of claim 1, further comprising a planar LED light source that emits either blue visible light or ultraviolet light, the light source being arranged on an opposite side of the capping layer than the liquid crystal layer.

9. A liquid crystal display device, comprising:
a substrate:
a pixel electrode arranged on the substrate;
a liquid crystal layer arranged on the pixel electrode;
a common electrode arranged on the liquid crystal layer and thrilling a microcavity with the pixel electrode;
a roof layer supporting the microcavity;
a first capping layer arranged on the roof layer;
a polarizer arranged on the first capping layer; and
a second capping layer and a third capping layer sequentially arranged on the polarizer, wherein the second capping layer includes a plurality of quantum dots dispersed within a polymer layer.

10. The liquid crystal display device of claim 9, wherein the quantum dots comprise:
a plurality of red quantum dots; and
a plurality of green quantum dots.

11. The liquid crystal display device of claim 10, wherein the first capping layer and the third capping layer are comprised of a polymer layer that is absent of any quantum dots.

12. The liquid crystal display device of claim 11, wherein the polymer layer of each of the first, second and third capping layers include a plastic resin that transmits light.

13. The liquid crystal display device of claim 12, wherein the quantum dots comprise at least one inorganic oxide selected from a group consisting of silica, alumina, titania, zirconia, and a combination thereof.

14. The liquid crystal display device of claim 9, further comprising:
a first alignment layer arranged on the pixel electrode;
a second alignment layer facing the first alignment layer with the microcavity therebetween; and
a common electrode arranged on the second alignment layer.

15. The liquid crystal display device of claim 10, wherein the third capping layer comprises a reflecting film.

16. The liquid crystal display device of claim 15, wherein the reflecting film transmits blue light while reflecting both green light and red light.

17. The liquid crystal display device of claim 16, wherein the reflecting film includes a dielectric multilayer structure that includes at least one layer including silicon oxide and at least one layer including titanium oxide.

18. The liquid crystal display device of claim 11, further comprising a reflecting film arranged on the third capping layer.

19. The liquid crystal display device of claim 18, wherein the reflecting film transmits blue light while reflecting both green light and red light.

20. The liquid crystal display device of claim 19, wherein the reflecting film includes a dielectric multilayer structure comprising at least one layer comprising silicon oxide and at least one layer comprising titanium oxide.
